(19) United States
(12) Patent Application Publication
(10) Pub. No.: US 2010/0320890 A1
(43) Pub. Date: Dec. 23, 2010

(54) Refrigerator

(75) Inventors: Sang Gyu Jung, Gwangju-si (KR); Ji Man Kim, Gwangju-si (KR); Chang Yong Kim, Gwangju-si (KR); Yun Ho Yang, Yongin-si (KR); Sang Woon Jeon, Namyangju-si (KR); Jae Moon Lee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/801,667

(22) Filed: Jun. 18, 2010

(30) Foreign Application Priority Data
Jun. 22, 2009 (KR) 10-2009-55564
Jul. 13, 2009 (KR) 10-2009-63318

(51) Int. Cl. F25D 23/02; G08B 21/00; F21V 33/00

(52) U.S. Cl. 312/402; 312/405; 340/686.1; 362/92; 315/312

(57) ABSTRACT

The refrigerator includes a main body provided with a first storage compartment and a second storage compartment, vertically divided from each other. a first storage compartment door and a second storage compartment door are vertically disposed so as to open and close the first storage compartment and the second storage compartment of the main body. an illumination unit is provided at least one of the lower end portion of the first storage compartment door and the upper portion of the second storage compartment. Also an input unit is provided to input operation data of the illumination unit.

### CROSS-REFERENCE TO RELATED APPLICATIONS

This application claims the benefit of Korean Patent Application No. 2009-0055564, filed on Jun. 22, 2009 and Korean Patent Application No. 2009-0063318, filed on Jul. 13, 2009 in the Korean Intellectual Property Office, the disclosures of which are incorporated herein by reference.

### BACKGROUND

1. Field

Embodiments relate to a refrigerator.

2. Description of the Related Art

A refrigerator is an apparatus that supplies cold air produced by a refrigeration cycle into a storage compartment, to keep food fresh for a long term.

Generally, such a refrigerator includes a plurality of storage compartments separated from one another, and doors to open or close the storage compartments or drawers to be pushed into or pulled out of the storage compartments. When a user opens the door to put or take, e.g., food into or out of the storage compartment, a lighting device provided at a fixed position in the storage compartment is turned on, thus allowing the user to easily see the food in the storage compartment.

### SUMMARY

Therefore, it is an aspect to provide a refrigerator having improved use convenience.

It is another aspect to provide a refrigerator having improved aesthetic value.

Additional aspects of the invention will be set forth in part in the description which follows and, in part, will be apparent from the description, or may be learned by practice of the invention.

In accordance with one aspect, a refrigerator includes a main body provided with a first storage compartment and a second storage compartment, vertically divided from each other, a first storage compartment door and a second storage compartment door vertically disposed so as to open and close the first storage compartment and the second storage compartment of the main body, an illumination unit provided at least one of the lower end portion of the first storage compartment door and the upper portion of the second storage compartment, an input unit provided to input operation data of the illumination unit.

The refrigerator may further include an opening and closing sensing unit to sense the opening and closing state of at least one of the first storage compartment door and the second storage compartment door and interlocking the illumination unit

The opening and closing sensing unit may include a reed switch provided at least one of the lower end portion of the first storage compartment door and the upper end portion of the second storage compartment door, and a magnet provided at the other one of the lower end portion of the first storage compartment door and the upper end portion of the second storage compartment door and interacting with the reed switch.

The opening and closing states of the first storage compartment door and the second storage compartment door may be simultaneously sensed by the interaction between the reed switch and the magnet.

The illumination unit may be operated when at least one of the first storage compartment door and the second storage compartment door is opened.

A user may input the operation data including a color, illuminance, and an on and off pattern of the illumination unit through the input unit.

The refrigerator may further include a brightness sensor, and the illumination unit may be operated according to a brightness value measured by the brightness sensor.

The input unit may allow the user to previously input an operational mode of the illumination unit based on the brightness value measured by the brightness sensor.

A user may select a mood function through the input unit, and the illumination unit may be operated as a mood light in the nighttime, when the mood function is selected.

A user may select an alarm function through the input unit, and the illumination unit may be operated as an alarm light, if the first storage compartment door or the second storage compartment door is opened for more than a designated time or a system error is generated under the condition that the alarm function is selected.

A gripping groove may be formed at the lower end portion of the first storage compartment door, and the illumination unit may include a light source installed in the gripping groove so as not to be exposed to the front surface of the first storage compartment door, and a transmission cover to cover the light source.

In accordance with another aspect, a refrigerator includes a main body in which a first storage compartment, a second storage compartment, and a third storage compartment are defined, these storage compartments being separated from one another, a first hinge door and a second hinge door hinged respectively to left and right sides of the main body and serving to open or close the first storage compartment of the main body, a first drawer configured to be pushed into or pulled out of the second storage compartment of the main body, a second drawer configured to be pushed into or pulled out of the third storage compartment of the main body, a first illumination unit provided at a lower end of at least one of the first hinge door and the second hinge door, a second illumination unit provided at a lower end of the first drawer and an input unit using which a user inputs a variety of information.

The refrigerator may further include a first opening and closing sensing unit to sense an opened or closed state of the first drawer and a second opening and closing sensing unit to sense an opened or closed state of the second drawer, wherein the first illumination unit is operated in a predetermined pattern during opening of the first drawer, and the second illumination unit is operated in a predetermined pattern during opening of the second drawer.

In accordance with a further aspect, a refrigerator includes a main body provided with a first storage compartment, a second storage compartment, and a third storage compartment, a first hinge door and a second hinge door respectively hinged to the left side and the right side of the main body so as to open and close the first storage compartment of the main body, a first drawer put into and taken out of the second storage compartment of the main body, a second drawer put into and taken out of the third storage compartment of the main body, first illumination units respectively provided at the lower end portions of the first hinge door and the second hinge door, a second illumination unit provided at the lower end portion of the first drawer, a first opening and closing sensing unit including a reed switch provided at one of the lower end portion of the first hinge door and the upper end portion of the first drawer, and a magnet provided at the other one of the lower end portion of the first hinge door and the upper end portion of the first drawer, a second opening and closing sensing unit including a reed switch provided at one of the lower end portion of the second hinge door and the upper end portion of the first drawer, and a magnet provided at the other one of the lower end portion of the second hinge door and the upper end portion of the first drawer, a third opening and closing sensing unit including a reed switch provided at one of the lower end portion of the first drawer and the upper end portion of the second drawer, and a magnet provided at the other one of the lower end portion of the first drawer and the upper end portion of the second drawer and an input unit provided to input operation data of at least one of the first illumination units and the second illumination unit, wherein the first illumination units and the second illumination unit are interlocked with the first opening and closing sensing unit, the second opening and closing sensing unit, and the third opening and closing sensing unit.

A user may input the operation data of the first illumination units and the second illumination unit through the input unit, and the first illumination units and the second illumination unit are operated according to the operation data input by the user.

In accordance with a further aspect, a refrigerator includes a main body provided with a first storage compartment and a second storage compartment, vertically divided from each other, a first storage compartment door and a second storage compartment door vertically disposed so as to open and close the first storage compartment and the second storage compartment of the main body, an illumination unit provided at least one of the lower end portion of the first storage compartment door and the upper portion of the second storage compartment and an opening and closing sensing unit to sense the opening and closing state of at least one of the first storage compartment door and the second storage compartment door and interlocking the illumination unit, wherein the illumination unit is operated when the second storage compartment door is opened and closed.

In accordance with a further aspect, a refrigerator includes a main body in which a first storage compartment and a second storage compartment are defined, a partition provided between the first storage compartment and the second storage compartment, to separate the first storage compartment and the second storage compartment from each other, a first storage compartment door to open or close the first storage compartment, a second storage compartment door to open or close the second storage compartment, a illumination unit provided on at least one of a lower end of the first storage compartment door and a lower end of the partition; and an input device to which a user inputs an operational mode of the illumination unit.

In accordance with further aspect of the present invention, in a control method of a refrigerator, the refrigerator including a main body in which a first storage compartment, a second storage compartment, and a third storage compartment are defined, a first hinge door and a second hinge door hinged respectively to left and right sides of the main body and serving to open or close the first storage compartment of the main body, a first drawer configured to be pushed into or pulled out of the second storage compartment of the main body, a second drawer configured to be pushed into or pulled out of the third storage compartment of the main body, a first illumination unit provided at a lower end of at least one of the first hinge door and the second hinge door, a second illumination unit provided at a lower end of the first drawer, and an input unit using which a variety of information is input, a user inputs operational information of the first illumination unit and the second illumination unit by use of the input unit, and the first illumination unit and second illumination unit are operated based on the operational information input by the user.

The input unit may allow the user to input the operational information of at least one of the first illumination unit and the second illumination unit, such as the luminous intensity, color and on-and-off pattern of light based on a time zone, season and storage compartment temperature.

### BRIEF DESCRIPTION OF THE DRAWINGS

These and/or other aspects will become apparent and more readily appreciated from the following description of the embodiments, taken in conjunction with the accompanying drawings of which:

FIG. 1 is a perspective view illustrating an external appearance of a refrigerator according to an embodiment;

FIG. 2 is a perspective view illustrating an opened state of each storage compartment of the refrigerator shown in FIG. 1;

FIG. 3 is a bottom perspective view of a first hinge door, a second hinge door and a first drawer according to the embodiment;

FIG. 4 is a control block diagram of the refrigerator according to the embodiment;

FIG. 5 is a perspective view illustrating an external appearance of a refrigerator according to another embodiment;

FIG. 6 is a perspective view illustrating a grip member of a first hinge door included in the refrigerator of FIG. 5; and

FIG. 7 is a control block diagram of the refrigerator according to another embodiment.

FIG. 8 is a perspective view illustrating the external appearance of a refrigerator in a door-opened state in accordance with the embodiment;

FIG. 9 is a perspective view illustrating the external appearance of the refrigerator of FIG. 1 in a door-closed state;

FIG. 10 is a longitudinal-sectional view taken along the line A-A of FIG. 2;

FIG. 11 is a perspective view illustrating the external appearance of a refrigerator in accordance with another embodiment; and

FIG. 12 is a view illustrating doors of the refrigerator of FIG. 4, as seen upwardly from the bottom.

### DETAILED DESCRIPTION

Reference will now be made in detail to the embodiments, examples of which are illustrated in the accompanying drawings, wherein like reference numerals refer to like elements throughout.

Hereinafter, an embodiment will be described in detail with reference to the accompanying drawings.

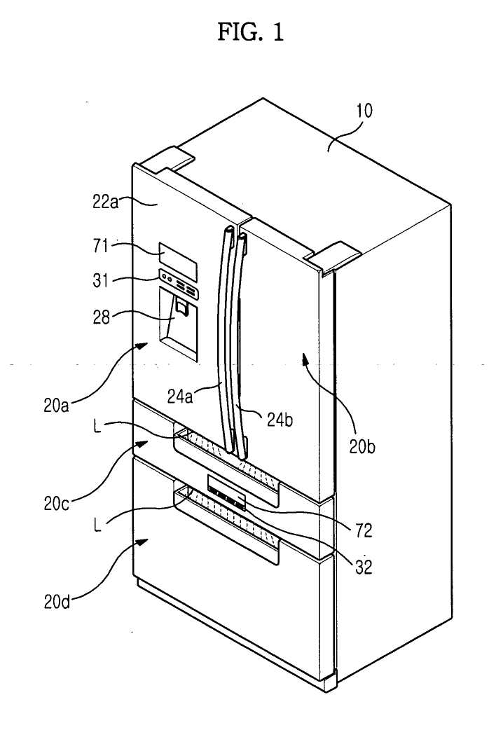

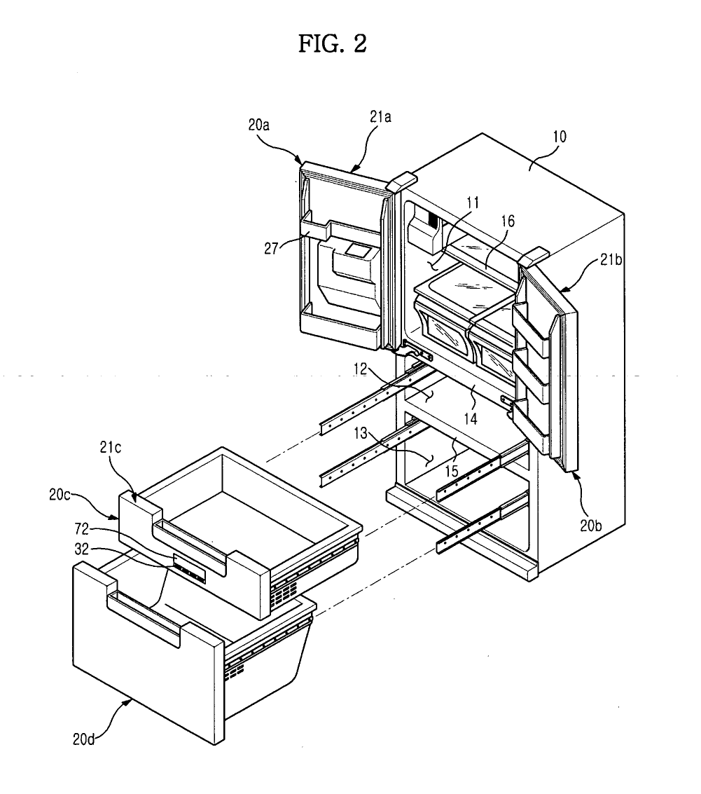

FIG. 1 is a perspective view illustrating an external appearance of a refrigerator according to an embodiment, and FIG. 2 is a perspective view illustrating an opened state of each storage compartment of the refrigerator shown in FIG. 1

As shown in FIGS. 1 and 2, the refrigerator includes a main body 10 in which a first storage compartment 11, a second storage compartment 12 and a third storage compartment 13 are defined, these storage compartments being separated from one another and each having an open front side, first and second hinge doors 20a and 20b hinged to left and right sides of the main body 10 to open or close the first storage compartment 11, a first drawer 20c configured to be pulled out or pushed into the second storage compartment 12 of the main body 10 in a drawer manner, and a second drawer 20d configured to be pulled out or pushed into the third storage compartment 13 of the main body 10 in a drawer manner. For reference, on the basis of FIG. 1, the first storage compartment 11 is located in an upper region of the refrigerator, the third storage compartment 13 is located in a lower region of the refrigerator, and the second storage compartment 12 is located between the first storage compartment 11 and the third storage compartment 13.

The main body 10 includes a first insulating partition 14 and a second insulating partition 15, which separate the first storage compartment 11, second storage compartment 12 and third storage compartment 13 from one another. The main body 10 is constructed by an inner shell, an outer shell, and a foam material filled between the inner shell and the outer shell. In this case, the main body 10 is integrally formed with the first and second insulating partitions 14 and 15, thus achieving enhanced insulation efficiency between the respective storage compartments. Reference numeral 16 represents shelves coupled to the main body 10 to aid effective storage of food.

The first storage compartment 11, second storage compartment 12 and third storage compartment 13, defined in the main body 10, respectively provides an independent storage space. Thus, a storage temperature of each storage compartment is independently controlled based on the quantity of cold air supplied into the corresponding storage compartment. Of course, the insulating partition provided between the second storage compartment and the third storage compartment may be omitted, and the form and configuration of the storage compartment may be modified variously.

Receiving shelves 27 are provided at different positions of inner surfaces of the first hinge door 20a and second hinge door 20b. The first hinge door 20a is further provided with a dispenser device 28. The dispenser device 28 functions to selectively discharge ice or water. Although not shown in the refrigerator of the present embodiment, at least one of the first hinge door 20a and second hinge door 20b may be provided with an auxiliary door. Reference numerals 24a and 24b represent grip members, which are provided respectively at the first hinge door 20a and second hinge door 20b. The user may grip the grip member upon opening of the corresponding door. Although the grip members of the present embodiment are shaped to protrude from the first hinge door 20a and second hinge door 20b, the shape of the grip members may be changed into various other shapes, e.g., grooves.

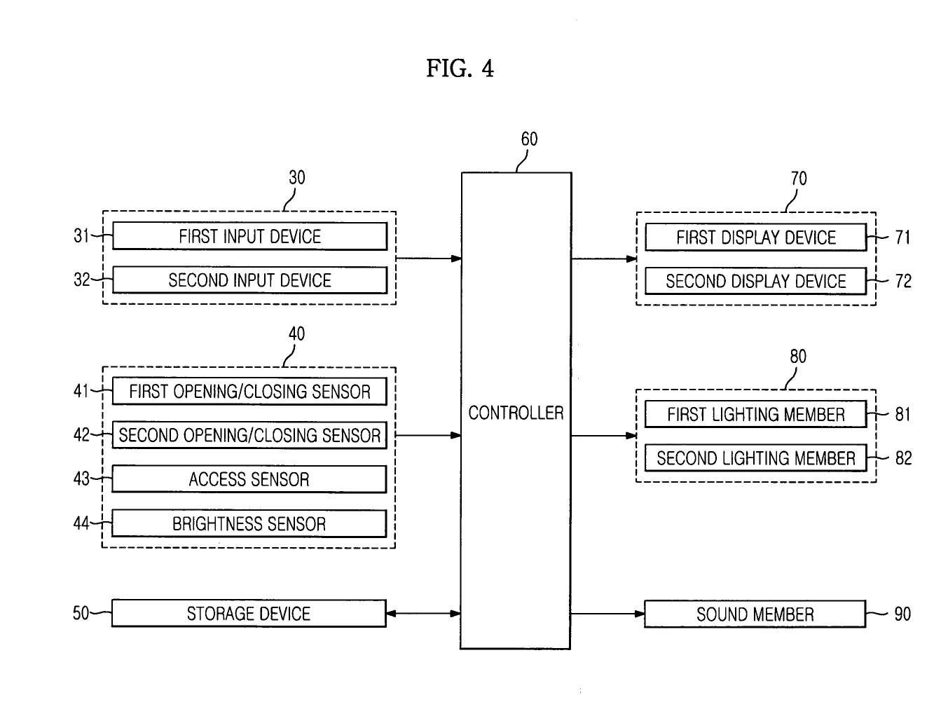

The refrigerator further includes an input unit 30 (see FIG. 4). The user may input various functional information of the refrigerator (e.g., food residence time in a storage compartment, and storage compartment temperature) by means of the input unit 30. In this case, the input unit 30 includes a first input unit 31 provided at a front surface 22a of a front panel 21a of the first hinge door 20a, and a second input unit 32 provided at a front surface 22c of a front panel 21c of the first drawer 20c. A display device 70 (see FIG. 4) may be provided near the first input unit 31 or the second input unit 32. The display device 70 displays input functions, setting modes, etc. In FIG. 1, reference numeral 71 represents a first display device, and reference numeral 72 represents a second display device. Of course, the first input unit 31 and second input unit 32 may take the form of a touch screen.

The refrigerator includes an evaporator, a compressor, an expander, and a condenser, which constitute a refrigeration cycle. Cold air produced by the refrigeration cycle is distributed and discharged into every region of each storage compartment through a cold air supply part defined in a rear side of the storage compartment. The configuration of the refrigeration cycle is generally known and thus, a description thereof will be omitted.

The refrigerator further includes a illumination unit 80 to emit light L, the illumination units being provided at the exterior of the refrigerator.

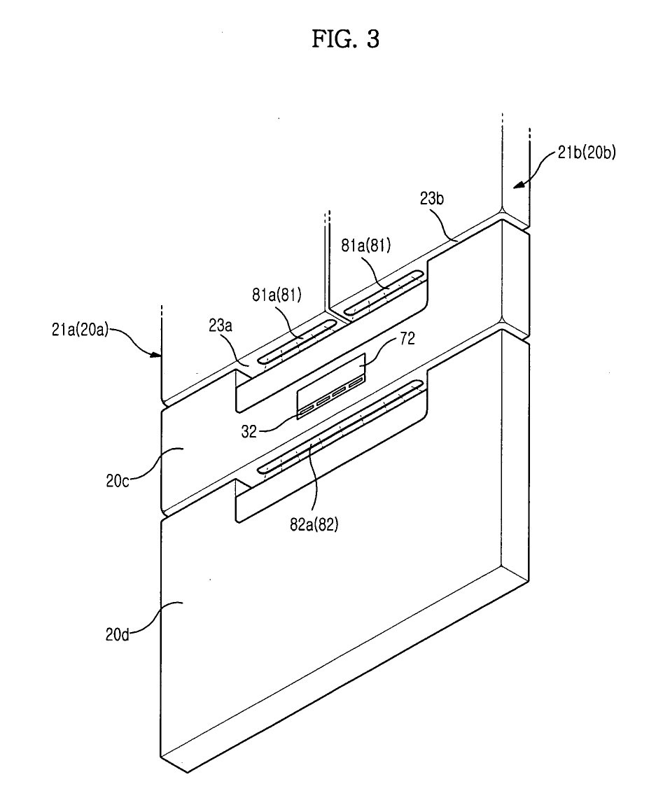

FIG. 3 is a bottom perspective view of the first hinge door, second hinge door and first drawer according to the embodiment.

The illumination unit 80 includes first illumination units 81 provided respectively at lower ends of the front panels 21a and 21b of the first hinge door 20a and second hinge door 20b, and a second illumination unit 82 provided at a lower end of the front panel 21c of the first drawer 20c.

Each of the first illumination units 81 may include an LED lamp (not shown), and a transparent window 81a. The LED lamp is inserted in a recess formed in a lower end surface 23a of the front panel 21a of the first hinge door 20a, or a lower end surface 23b of the front panel 21b of the second hinge door 20b. The transparent window 81a is installed to the first hinge door 20a or the second hinge door 20b and thus, serves to protect the LED lamp from the outside and to diffuse the light L emitted from the LED lamp. In the refrigerator shown in FIG. 3, although both the first illumination units 81 are provided respectively at the first hinge door 20a and second hinge door 20b, the first illumination unit 81 may be provided at one of the first and second hinge doors 20a and 20b. In this case, the front panel 21a of the first hinge door 20a and the front panel 21b of the second hinge door 20b may protrude forward from the main body 10 by a predetermined thickness.

The second illumination unit 82 may include an LED lamp inserted in a recess formed in a lower end surface 23c of the front panel 21c of the first drawer 20c, and a transparent window 82a installed to the first drawer 20c and serving to protect the LED lamp from the outside and to diffuse the light L emitted from the LED lamp. In this case, the front panel 21c of the first drawer 20c protrudes forward from the main body 10 by a predetermined thickness.

The above-described LED lamp and transparent window are given by way of example, and a light source to emit light and the material and configuration of the transparent window are not specifically limited. For example, although the LED lamp may be a linear light source and the transparent window may be made of resin, the LED lamp may be a plurality of point light sources and the transparent window may be omitted. Alternatively, the LED lamp may include a plurality of light sources of different colors. Of course, in addition to the LED lamp, an incandescent lamp, a halogen lamp, a fluorescent lamp, etc. may be used as a light emitting member.

FIG. 4 is a control block diagram of the refrigerator according to the embodiment. The refrigerator includes the input unit 30, sensing device 40, storage device 50, controller 60, display device 70, illumination unit 80, and a sound member 90.

The input unit 30, as described above, includes the first input unit 31 and second input unit 32. The user may input a variety of information and commands related to the operation and convenient functions of the refrigerator by means of the first input unit 31 and second input unit 32. Information input via the input unit 30 is stored in the storage device 50, or is processed by the controller 60.

The sensing device 40 includes a first opening and closing sensing unit 41, a second opening and closing sensing unit 42, and an access sensor 43.

The first opening and closing sensing unit 41 outputs signals corresponding to an opened or closed state of the first drawer 20c to the controller 60, and the second opening and closing sensing unit 43 outputs signals corresponding to an opened or closed state of the second drawer 20d to the controller 60. In this case, the first opening and closing sensing unit 41 and second opening and closing sensing unit 42 may be realized into various types, such as an optical sensor type, switch type, etc.

The access sensor 43 outputs signals corresponding to an access distance of an object including the user by sensing access of the object.

A brightness sensor 44 may also be provided. The brightness sensor 44 outputs signals corresponding to the brightness around the refrigerator to the controller 60.

The storage device 50 stores the various input information, use history, etc.

The controller 60 is a microcomputer to control general operations of the refrigerator and thus, controls, e.g., the refrigeration cycle of the refrigerator, the illumination unit 80 and the sound member 90 based on the information input using the input unit 30 and data stored in the storage device 50.

The display device 70 may display, e.g., a moving image screen or internet screen as well as the operational mode of the refrigerator.

The first illumination unit 81 and second illumination unit 82 may illuminate the interior of the corresponding drawer when the corresponding storage compartment is opened. Specifically, the first illumination unit 81 may illuminate the interior of the first drawer 20c when the second storage compartment 12 is opened, and the second illumination unit 82 may illuminate the interior of the second drawer 20d when the third storage compartment 13 is opened. Thereby, when the user takes food out of the first drawer 20c or the second drawer 20d, the user may more easily discern the food. In particular, in the drawer type storage configuration, the drawer protrudes out of the refrigerator upon opening thereof and therefore, there is a high possibility of the user taking food out of a partial drawer region exposed to outside light. However, in the present embodiment, due to the fact that the first illumination units 81 and second illumination unit 82 are provided at the lower ends of the front panels 21a, 21b and 21c of the respective doors 20a and 20b and the first drawer 20c, when the drawer located below the corresponding illumination unit is opened, the illumination unit illuminates a partial interior region of the drawer, i.e. a region immediately behind the partial drawer region exposed to outside light. In this way, the illumination unit illuminates the region which is not exposed to the outside light but receives some food, thus allowing the user to very easily discern and take out food.

The light sources of the first illumination units 81 and the light source of the second illumination unit 82 are inserted in the recesses formed in the lower end surfaces 23a, 23b and 23c of the respective front panels 21a, 21b and 21c and thus, are hidden when viewed from the front. Thus, the first and second illumination units 81 and 82 may be used as a so-called mood lamp that creates a distinctive emotional condition, i.e. luxury environment. This is because light emitted from the light sources is directed downward, rather than directly illuminating the user. In this case, the user may input a variety of operational information of the first and second illumination units 81 and 82 by means of the input unit 30. Here, the operational information of the first and second illumination units 81 and 82 may include, e.g., colors, luminous intensities and on-and-off patterns that depend on a time zone, season, and storage compartment temperature, etc. For example, the light source may be turned on to emit light of a high chroma color and high luminous intensity during the daytime exhibiting a lot of natural light, or may be turned on to emit light of a low chroma color and low luminous intensity during the nighttime exhibiting insufficient natural light. In addition, the input unit 30 may be used to set various functions, such as a mood function, alarm function, etc., and the user may select any one of the set functions. If the user selects the mood function, the first illumination unit 81 or the second illumination unit 82 may function as a mood lamp. If the user selects the alarm function, the first illumination unit 81 or the second illumination unit 82 may function as an alarm lamp that informs the user of any system error or a situation in which the refrigerator door is opened for a predetermined or more time. Of course, the first and second illumination units 81 and 82 may be set such that on-and-off patterns thereof are changed according different time zones. Such setting information may be stored in the storage device 50.

Also, at least one of the first illumination unit 81 and second illumination unit 82 may be operated based on a brightness value measured by the brightness sensor 44. For example, if the brightness sensor 44 senses a low brightness value even during the daytime, that is, if the luminous intensity of the surroundings is low, at least one of the first illumination unit 81 and second illumination unit 82 may be turned on like a mood lamp.

The user may previously input operational modes of the first and second illumination units 81 and 82 by means of the input unit 30. Here, the operational modes depend on the brightness value measured by the brightness sensor 44. For example, the user may directly set the colors and luminous intensities of the first and second illumination units 81 and 82 based on the brightness value measured by the brightness sensor 44.

The first illumination unit 81 and second illumination unit 82 may also be used as warning lamps that inform the user of a situation in which the drawers 20c and 20d of the corresponding storage compartments 12 and 13 are incompletely closed. The first illumination unit 81 may exhibit a predetermined on-and-off pattern during opening of the first drawer 20c, and the second illumination unit 82 may exhibit a predetermined on-and-off pattern during opening of the second drawer 20d. In this case, the first illumination unit 81 and second illumination unit 82 may be turned on and off in a first pattern for a predetermined time after the corresponding drawer 20c or 20d is opened and then, may be turned on and off in a second pattern different from the first pattern after the predetermined time passes. This may effectively prevent the first drawer 20c and second drawer 20d from being left in an opened state, thus preventing the leakage of cold air.

Also, the first and second illumination units 81 and 82 may be turned on and off in different patterns based on the access degree of an object. The access sensor 43 senses the access of an object including a person, so as to output access signals to the controller 60. Thus, the controller 60 may control, e.g., the colors, luminous intensities and on-and-off patterns of the first and second illumination units 81 and 82 based on the signals from the access sensor 43. Thereby, the user may more actively recognize the refrigerator with enhanced aesthetic appreciation. In addition, when no human activity is sensed for a long term, the first and second illumination units 81 and 82 may be turned off for reduction of energy consumption.

The sound member 90 may generate a variety of sounds including warning sounds that inform the user of the opening of the refrigerator door. Of course, the sound member 90 may reproduce and output various types of sound sources.

Hereinafter, another embodiment will be described with reference to the accompanying drawings. For reference, the same or like components as the previously described components will be described by the same reference numerals and a description thereof will be omitted.

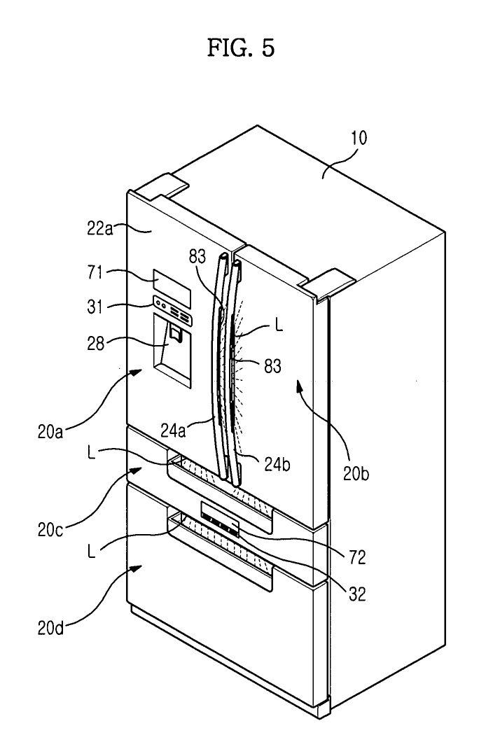

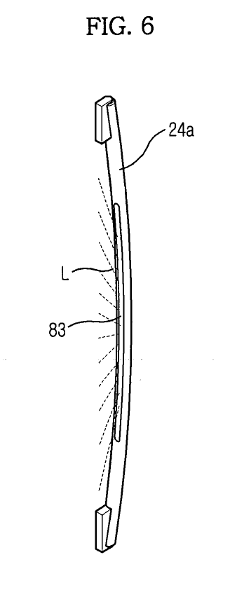

FIG. 5 is a perspective view illustrating an external appearance of a refrigerator according to another embodiment of the present invention, and FIG. 6 is a perspective view illustrating a grip member of a first hinge door included in the refrigerator of FIG. 5. For reference, although the grip member 24a of the first hinge door 20a will be described hereinafter by way of example, the following description will be equally applied to the grip member 24b of the second hinge door 20b.

The refrigerator further includes third illumination units 83 provided respectively at the grip member 24a of the first hinge door 20a and the grip member 24b of the second hinge door 20b.

The third illumination units 83 are installed to rear surfaces of the grip member 24a of the first hinge door 20a and the grip member 24b of the second hinge door 20b, and may be used as mood lamps to emit light rearward. In this case, the above-described use examples of the first and second illumination units 81 and 82 may be equally applied to the third illumination units 83. Of course, the third illumination unit 83 may be provided at one of the first and second hinge doors 20a and 20b, and may be installed to the front panel of the door at a position adjacent to the grip member, rather than being installed to the rear surface of the grip member.

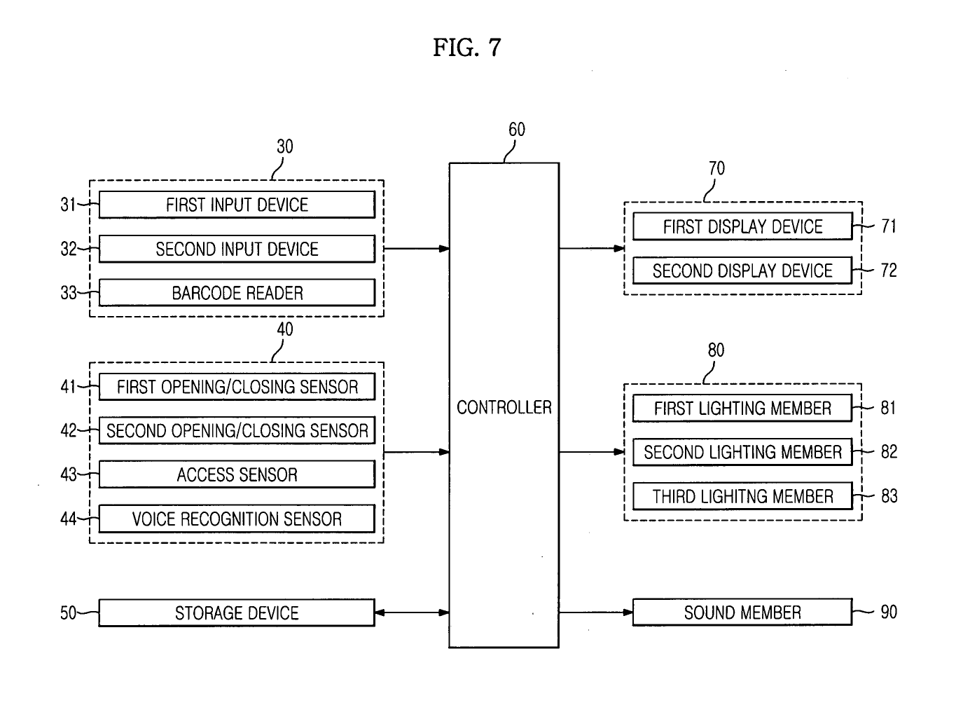

FIG. 7 is a control block diagram of the refrigerator according to another embodiment.

The input unit 30 further includes a barcode reader 33 that reads a barcode of goods. Thus, the user may store information of food, e.g., the title, expiration date and storage period of food in the storage device 50 by means of the barcode reader 33 without a separate input operation. The barcode reader 33 may be provided at each storage compartment 11, 12 or 13. In this case, even if the user does not additionally input the storage position of food (i.e. whether the food is stored in the first storage compartment, the second storage compartment, or the third storage compartment), the storage position of food may be automatically stored in the storage device 50. Of course, the refrigerator may include a single barcode reader. In this case, the user may input the storage position of food by means of the first input unit 31 or the second input unit 32, so as to store the storage position information in the storage device 50. Also, the user may input all information, such as the title, expiration date, residual storage period, and storage position of food, by means of the first input unit 31 or the second input unit 32.

The sensing device 40 may further include a voice recognition sensor 45 that recognizes the user's voice. The voice recognition sensor 45 outputs signals corresponding to the recognized user's voice to the controller 60. Thus, the controller 60 may actively deal with the user demand by operating the first, second and third illumination units 81, 82 and 83 and the sound member 90 based on the signals input from the voice recognition sensor 45. Also, e.g. the title of food to be stored may be converted into voice data, so as to be stored in the storage device 50.

The user may confirm e.g. the storage data and residual storage period of stored food via the display device and thus, may first use food having a short residual storage period, or dispose food that is no longer fresh because the expiration date of food passes.

Also, the user may select one of stored food by means of, e.g., the first input unit 31, second input unit 32 and voice recognition sensor 45. The illumination unit, which corresponds to the storage compartment containing the selected food, is turned on and off in a predetermined pattern, to inform the user of the storage position of the selected food. In this case, the illumination unit may be turned on and off in different colors and on-and-off patterns based on the residual storage period of the stored food.

For example, when the user puts milk into the first storage compartment, the user may store data (including voice data), such as the title, residual storage period (expiration date), and storage position of the milk in the storage device 50. Then, if the user selects a word “milk” by means of the first input unit 31 or the second input unit 32, or inputs a vocal word “milk” by means of the voice recognition sensor 45, the third illumination unit 83 corresponding to the first storage compartment 11 is turned on and off. In this case, when the residual storage period of the milk is sufficient and thus, the milk is fresh, a green lamp may be turned on and off. On the other hand, when the expiration date of the milk passes and thus, the milk is no longer fresh, a red lamp may be turned on and off. This enables the intake of fresh safe food, and the quantity of food that is left in the refrigerator for a long term may be reduced. Of course, in addition to the colors of the lamp, on-and-off patterns, i.e. on-and-off rate or on-and-off interval of the lamp may be utilized for easy recognition of the user.

Although the above description is based on the use example of the first and second illumination units 81 and 82, the use example is given by way of example, and the first and second illumination units 81 and 82 may be utilized in various manners.

For example, the above functions may be applied to all the first to third illumination units 81, 82 and 83, or may be applied to only one of the first to third illumination units 81 to 83.

Also, the number and position of the illumination units have no special limit. For example, the first illumination unit 81, which corresponds to the second storage compartment 12 and first drawer 20c, may be provided at only one of the first and second hinge doors 20a and 20b.

Although the refrigerator of a Bottom Mounted Freezer (BMF) type has been described herein by way of example, the embodiments may be applied to a Top Mounted Freezer (TMF) type refrigerator, or a side by side type refrigerator. Also, although the refrigerator having three storage compartments has been described herein by way of example, the number of storage compartments is not limited. For example, only the first storage compartment and second storage compartment may be provided without the third storage compartment. Of course, in this case, the second illumination unit 82 may be omitted.

The hinge door may be replaced by the drawer. Alternatively, the drawer may be replaced by the hinge door. Accordingly, it will be understood that the door described herein may be of a hinge door type or of a drawer type.

The brightness of light produced by the illumination unit may be adjusted by controlling the number of light emitting elements, or by controlling the current or voltage applied to the light emitting elements.

A variety of information, such as titles and expiration dates of representative foods, etc., may be previously stored in the storage device 50 in the manufacture stage of products. In this case, the user may select food based on a food list.

The refrigerator further includes a barcode output device, to attach a barcode output from the barcode output device to food to be stored in the refrigerator. In this case, with respect to the storage of food that is frequently removed and stored again after use, such as beverages, it may be possible to reduce the quantity of information to be input using the input unit 30 whenever the food is removed from or stored in the refrigerator.

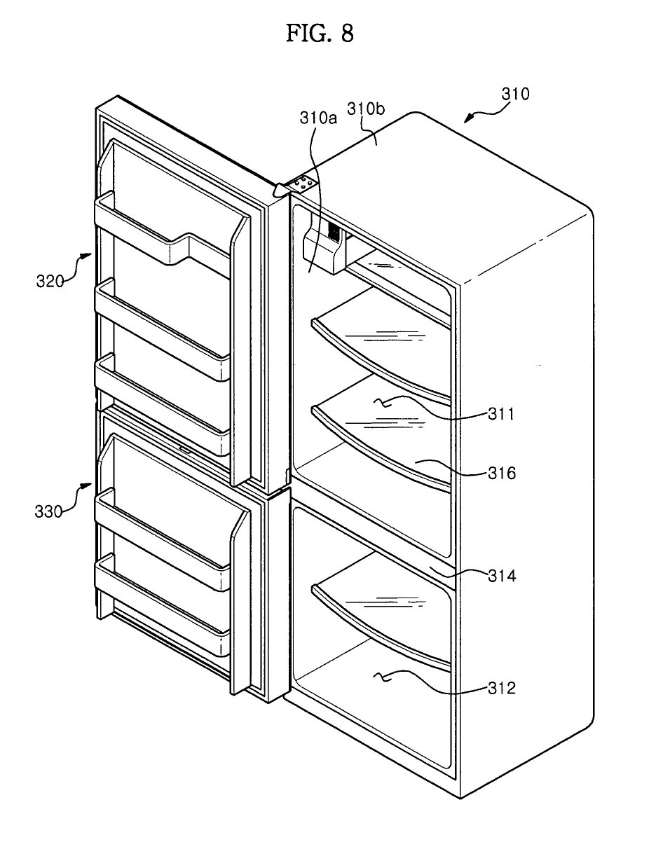

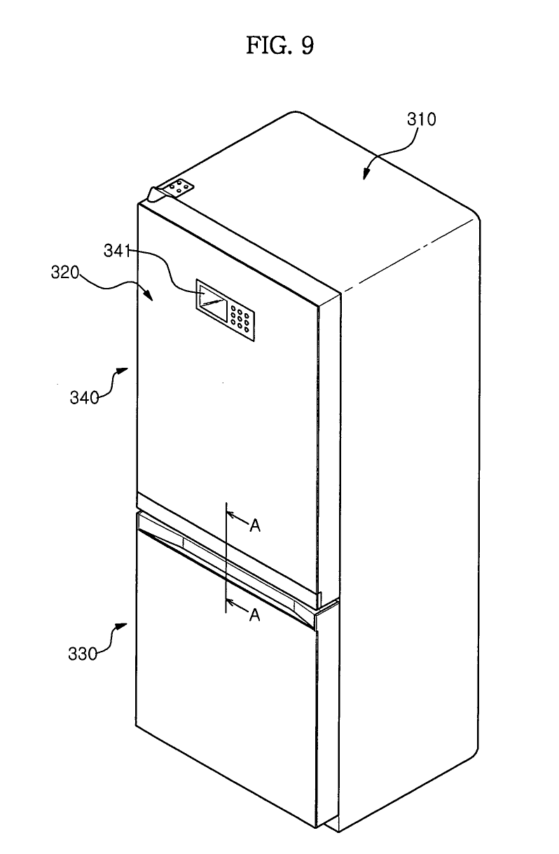

FIG. 8 is a perspective view illustrating the external appearance of a refrigerator in a door-opened state in accordance with a third embodiment, and FIG. 9 is a perspective view illustrating the external appearance of the refrigerator of FIG. 8 in a door-closed state.

As shown in FIGS. 8 and 9, the refrigerator in accordance with the third embodiment includes a main body 310 vertically divided into a first storage compartment 311 and a second storage compartment 312, the front surfaces of which are opened, a first storage compartment door 320 hinged to the main body 310 to open and close the first storage compartment 311, and a second storage compartment door 330 hinged to the main body 310 to open and close the second storage compartment 312.

The refrigerator in accordance with the third embodiment is a bottom mounted freezer (BMF)-type refrigerator, and thus the first storage compartment 311 serves as a refrigerating chamber and the second storage compartment 312 serves as a freezing chamber. However, inner temperatures of the first storage compartment 311 and the second storage compartment 312 may be adjusted. Further, although the third embodiment illustrates that the first storage compartment 311 and the second storage compartment 312 are opened and closed by the hinge-type doors 320 and 330, drawers instead of the doors 320 and 330 may be put into and taken out of the first and second storage compartments 311 and 312. Moreover, the shapes and the number of the doors 320 and 330 are not limited, and the number of the storage compartments 311 and 312 is not limited to two.

The main body 310 is provided with an insulating diaphragm 314 to divide the first storage compartment 311 and the second storage compartment 312 from each other. The main body 310 includes an inner case 310a, an outer case 310b, and a foaming agent filling a gap between the inner case 310a and the outer case 310b. Here, the main body 310 and the first insulating diaphragm 313 are formed integrally, and thus an insulating property of the respective storage compartments 311 and 312 is improved. Reference numeral 316 represents racks connected to the main body 310 to receive foods to be stored.

The first storage compartment 311 and the second storage compartment 312 formed in the main body 310 respectively form independent storage spaces, and storage temperatures of the first and second storage compartments 311 and 312 are independently controlled according to amounts of cool air supplied to the first and second storage compartments 311 and 312.

The refrigerator further includes an input unit 340 to receive input of various functions (for example, times and storage temperatures of the storage compartments) from a user. The input unit 340 is provided on the front surface of the first storage compartment 320, and includes a display unit 341. Through the display unit 341, the user may confirm contents of input data and a current state of the refrigerator. The input unit 340 may be provided in a touch screen manner.

The refrigerator further includes an evaporator, a compressor, an expansion device, and a condenser, which form a refrigerating cycle. Cool air generated by the refrigerating cycle is discharged to respective portions of the storage compartments 311 and 312 through cool air supply units respectively provided at rear portions of the storage compartments 311 and 312. The configuration of the refrigerating cycle is well known, and a detailed description thereof will thus be omitted.

The refrigerator further includes an illumination unit 350 emitting illumination light, and an opening and closing sensing unit 360 sensing an opening and closing state of at least one of the first storage compartment door 320 and the second storage compartment door 330 and interlocked with the illumination unit 350.

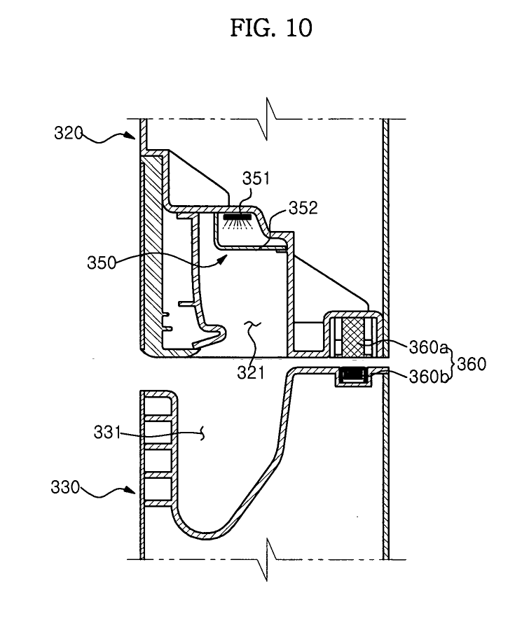

FIG. 10 is a longitudinal-sectional view taken along the line A-A of FIG. 9.

As shown in FIG. 10, the illumination unit 350 is provided at the lower end portion of the first storage compartment door 320. In more detail, the illumination unit 350 includes a light source 351 installed in a gripping groove 321 formed at the lower end portion of the first storage compartment door 320 so as not to be exposed to the front surface of the refrigerator, and a transmission cover 352 to cover the light source 351.

The gripping groove 321 of the first storage compartment door 320 is provided at the lower end portion of the first storage compartment door 320, and a gripping groove 331 of the second storage compartment door 330 is provided at the upper end portion of the second storage compartment door 330. The user may open and close the first storage compartment door 320 and the second storage compartment door 330 using the gripping groove 321 and the gripping groove 331. In the refrigerator in accordance with this embodiment, the gripping grooves 321 and 331 corresponding to handles are not exposed to the front surface of the refrigerator, and thus the aesthetic appearance of the refrigerator is improved. Further, since the gripping grooves 321 and 331 corresponding to handles are not exposed to the front surface of the refrigerator, a size of a container to pack the refrigerator is reduced, and a load efficiency when the refrigerator is loaded in a space, such as a container, is raised. Of course, it is possible to prevent a breakage of handles generated when the refrigerator is carried.

The light source 351 may be a general light emitting diode (LED) lamp. Of course, the light source 351 may be an incandescent lamp, a halogen lamp, or a fluorescent lamp in addition to the LED lamp.

The light source 351 is inserted into the gripping groove 321, which is not exposed to the front surface of the refrigerator, and illumination light from the light source 351 is emitted downward from the gripping groove 321. Therefore, the user may easily look for positions of the gripping groove 321 of the first storage compartment door 320 and the gripping groove 331 of the second storage compartment 330 even in the dark. Further, when food is discharged from the second storage compartment 312, the refrigerator in accordance with third embodiment may create a luxurious image around the refrigerator based on the light emitted from the light source 351 of the illumination unit 351.

The transmission cover 352 serves to protect the light source 351 from the outside and allow illumination light generated from the light source 351 to be softly dispersed. The transmission cover 352 may be made of a transparent or opaque resin. Of course, materials, colors, and shapes of the transmission cover 352 are not limited. The transmission cover 352 may have various materials, colors, and shapes according to desired effects.

The opening and closing sensing unit 360 includes a reed switch 360a provided at the lower end portion of the first storage compartment door 320, and a magnet 360b provided at the upper end portion of the second storage compartment door 330.

As shown in FIG. 10, when the magnet 360b faces the reed switch 360a, the reed switch 360a is operated, and outputs a corresponding signal to a control unit (not shown). Therefore, in the refrigerator in accordance with this embodiment, opening and closing states of both the first and second storage compartment doors 320 and 330 are simultaneously sensed by one opening and closing sensing unit 360. That is, the opening and closing sensing unit 360 senses opening of the first storage compartment door 320 and opening of the second storage compartment door 330. If the first storage compartment door 320 and the second storage compartment door 330 respectively maintain an opened state at the same angle, the opening and closing sensing unit 360 may incorrectly sense that both the first storage compartment door 320 and the second storage compartment door 330 are closed. However, since a case in that the first storage compartment door 320 and the second storage compartment door 330 are opened at the same angle without user's intension is rare, such incorrect sensing is not a concern under real-world operating conditions.

Of course, the magnet 360b may be installed at the lower end portion of the first storage compartment door 320, and the reed switch 360a may be installed at the upper end portion of the second storage compartment 330. Further, the refrigerator may include two or more opening and closing sensing units.

Since the illumination unit 350 is provided at the lower end portion of the first storage compartment door 320, as described above, discharge of food from the second storage compartment 312 is easy.

Further, the light source 351 of the illumination unit 350 is installed in the gripping groove 321 formed at the lower end portion of the first storage compartment door 320, and thus is hidden as seen from the front. Since illumination light generated from the light source 351 is not irradiated directly onto a user and is emitted downward, the illumination unit 350 may be used as a mood light arousing a soft and luxurious atmosphere.

The illumination unit 350 may be interlocked with the opening and closing sensing unit 360. For example, the illumination unit 350 may be used as an alarm light to inform a user of a state in which the first storage compartment door 320 and the second storage compartment door 330 are not completely closed. Thereby, leakage of cool air caused by leaving the first and second storage compartment doors 311 and 312 in the opened state is effectively prevented. Moreover, the illumination unit 350 may be used as an alarm light to inform a user of generation of a system error.

Further, a user may input operation data, such as a color, illuminance, and an on and off pattern of the illumination unit 350, according to time, season, and storage compartment temperature through the input unit 340. For example, in the daytime when the intensity of natural light is high, the light source 350 is turned on in a color having a high saturation at a high illuminance, and in the nighttime when the intensity of natural light is low, the light source 350 is turned on in a color having a low saturation at a low illuminance. Of course, the user may reset contents of functions, such as a mood function and an alarm function, i.e., an on and off pattern, so as to be suited to the user, and select one of set functions.

The refrigerator may further include a brightness sensor (not shown), and the light source 351 of the illumination unit 350 may be operated according to a brightness value measured by the brightness sensor. For example, if the brightness value measured by the brightness sensor is low even in the daytime, i.e., if illuminance around the refrigerator is low, the illumination unit 350 may be turned on as a mood light.

In addition to improvement in the illumination function, the refrigerator in accordance with the third embodiment improves productivity. That is, one opening and closing sensing unit 360 simultaneously senses the opening and closing of the first storage compartment door 320 and the second storage compartment door 330, thereby reducing production costs and man-hour.

Hereinafter, a fourth embodiment will be described with reference to the accompanying drawings. For reference, some parts in this embodiment, which are substantially the same as those in the earlier embodiment, are denoted by the same reference numerals even though they are depicted in different drawings, and a detailed description thereof will thus be omitted because it is considered to be unnecessary.

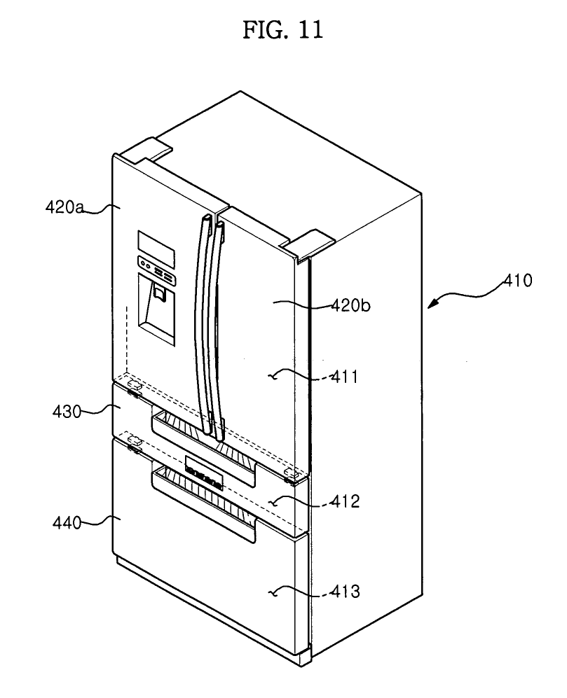

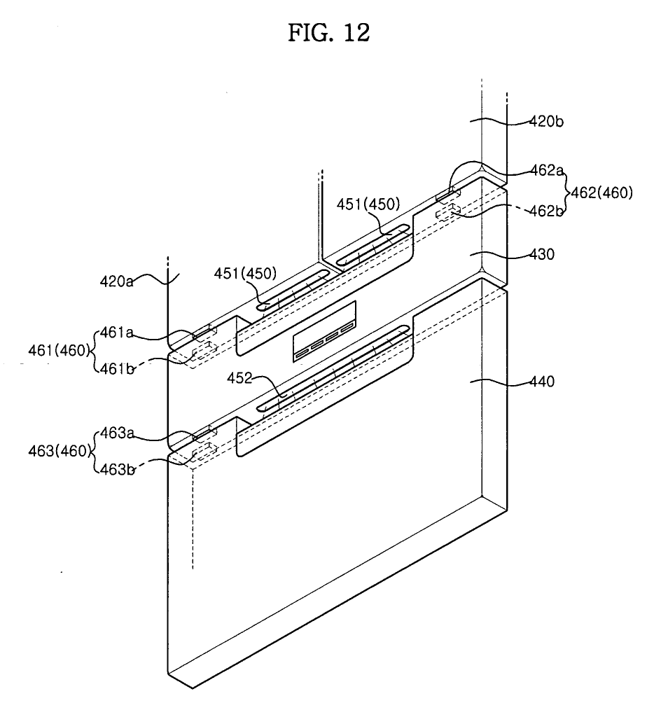

FIG. 11 is a perspective view illustrating the external appearance of a refrigerator in accordance with the fourth embodiment, and FIG. 12 is a view illustrating doors of the refrigerator of FIG. 11, as seen upwardly from the bottom.

As shown in FIGS. 11 and 12, the refrigerator in accordance with the fourth embodiment includes a main body 410 provided with a first storage compartment 411, a second storage compartment 412, and a third storage compartment 413, a first hinge door 420a and a second hinge door 420b respectively hinged to left and right sides of the main body 410 so as to open and close the first storage compartment 411, a first drawer 430 put into and taken out of the second storage compartment 412, and a second drawer 440 put into and taken out of the third storage compartment 413.

The refrigerator further includes illumination units 450, and opening and closing sensing units 460.

The illumination units 450 include first illumination units 451 respectively provided at the lower end portions of the first hinge door 420a and the second hinge door 420b, and a second illumination unit 452 provided at the lower end portion of the first drawer 430.

The opening and closing sensing units 460 include a first opening and closing sensing unit 461, a second opening and closing sensing unit 462, and a third opening and closing sensing unit 463. The first opening and closing unit 461 includes a reed switch 461a provided at the lower end portion of the first hinge door 420a, and a magnet 461b provided at the upper end portion of the first drawer 430. The second opening and closing unit 462 includes a reed switch 462a provided at the lower end portion of the second hinge door 420b, and a magnet 462b provided at the upper end portion of the first drawer 430. The third opening and closing unit 463 includes a reed switch 463a provided at the lower end portion of the first drawer 430, and a magnet 463b provided at the upper end portion of the second drawer 440. Here, the positions of the respective reed switches 461a, 462a, and 463a, and the positions of the magnets 461b, 462b, and 463b corresponding to the reed switches 461a, 462a, and 463a may be interchanged.

Thereby, whether or not the first hinge door 420a is opened and closed is sensed by the first opening and closing sensing unit 461, and the whether or not the second hinge door 420b is opened and closed is sensed by the second opening and closing sensing unit 462. Further, whether or not the first drawer 430 is opened and closed is sensed by the first opening and closing sensing unit 461, the second opening and closing sensing unit 462, and the third opening and closing sensing unit 463. Moreover, whether or not the second drawer 440 is opened and closed is sensed by the third opening and closing sensing unit 463.

The first illumination units 451 and the second illumination unit 452 may be operated as alarm lights, which are interlocked with the first opening and closing sensing unit 461, the second opening and closing sensing unit 462, and the third opening and closing sensing unit 463. Of course, the first illumination units 451 and the second illumination unit 452 may be operated as mood lights.

The components of the refrigerator in accordance with fourth embodiment may be variously modified. For example, the number and constitution of the storage compartments of the refrigerator are not limited. Further, the number of the light sources of the illumination unit is not limited. The brightness of illumination light emitted from the illumination unit may be controlled through the number of the light sources, or may be controlled by adjusting the intensity of power supplied to the light sources. The illumination unit may exert various functions in addition to functions as an alarm light and a mood light.

As is apparent from the above description, a refrigerator according to the embodiments of the present invention may attain improved use convenience and aesthetic value.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A refrigerator comprising:
a main body provided with a first storage compartment and a second storage compartment, vertically divided from each other;
a first storage compartment door and a second storage compartment door vertically disposed so as to open and close the first storage compartment and the second storage compartment of the main body;
an illumination unit provided at least one of the lower end portion of the first storage compartment door and the upper portion of the second storage compartment; and
an input unit provided to input operation data of the illumination unit.

2. The refrigerator according to claim 1, further comprising an opening and closing sensing unit to sense the opening and closing state of at least one of the first storage compartment door and the second storage compartment door and interlocking the illumination unit.

3. The refrigerator according to claim 2, wherein the opening and closing sensing unit includes a reed switch provided at least one of the lower end portion of the first storage compartment door and the upper end portion of the second storage compartment door, and a magnet provided at the other one of the lower end portion of the first storage compartment door and the upper end portion of the second storage compartment door and interacting with the reed switch.

4. The refrigerator according to claim 3, wherein the opening and closing states of the first storage compartment door and the second storage compartment door are simultaneously sensed by the interaction between the reed switch and the magnet.

5. The refrigerator according to claim 1, wherein the illumination unit is operated when at least one of the first storage compartment door and the second storage compartment door is opened.

6. The refrigerator according to claim 1, wherein a user is capable of inputting the operation data including a color, illuminance, and an on and off pattern of the illumination unit through the input unit.

7. The refrigerator according to claim 1, further comprising a brightness sensor, wherein the illumination unit is operated according to a brightness value measured by the brightness sensor, and the input unit allows the user to previously input an operational mode of the illumination unit based on the brightness value measured by the brightness sensor.

8. The refrigerator according to claim 1, wherein:
a user is capable of selecting a mood function through the input unit; and
the illumination unit is operated as a mood light in the nighttime, when the mood function is selected.

9. The refrigerator according to claim 1, wherein:
a user is capable of selecting an alarm function through the input unit; and
the illumination unit is operated as an alarm light, if the first storage compartment door or the second storage compartment door is opened for more than a designated time or a system error is generated under the condition that the alarm function is selected.

10. The refrigerator according to claim 1, wherein:
a gripping groove is formed at the lower end portion of the first storage compartment door; and
the illumination unit includes a light source installed in the gripping groove so as not to be exposed to the front surface of the first storage compartment door, and a transmission cover to cover the light source.

11. A refrigerator comprising:
a main body provided with a first storage compartment and a second storage compartment, vertically divided from each other;
a first storage compartment door and a second storage compartment door vertically disposed so as to open and close the first storage compartment and the second storage compartment of the main body;
an illumination unit provided at least one of the lower end portion of the first storage compartment door and the upper portion of the second storage compartment; and
an opening and closing sensing unit to sense the opening and closing state of at least one of the first storage compartment door and the second storage compartment door and interlocking the illumination unit,
wherein the opening and closing sensing unit includes a reed switch provided at least one of the lower end portion of the first storage compartment door and the upper end portion of the second storage compartment door, and a magnet provided at the other one of the lower end portion of the first storage compartment door and the upper end portion of the second storage compartment door and interacting with the reed switch, and the opening and closing states of the first storage compartment door and the second storage compartment door are simultaneously sensed by the interaction between the reed switch and the magnet.

12. The refrigerator according to claim 11, further comprising:
a first opening and closing sensing unit to sense an opened or closed state of the first drawer; and
a second opening and closing sensing unit to sense an opened or closed state of the second drawer,
wherein the first illumination unit is operated in a predetermined pattern during opening of the first drawer, and the second illumination unit is operated in a predetermined pattern during opening of the second drawer.

13. A refrigerator comprising:
a main body provided with a first storage compartment, a second storage compartment, and a third storage compartment;
a first hinge door and a second hinge door respectively hinged to the left side and the right side of the main body so as to open and close the first storage compartment of the main body;
a first drawer put into and taken out of the second storage compartment of the main body;
a second drawer put into and taken out of the third storage compartment of the main body;
first illumination units respectively provided at the lower end portions of the first hinge door and the second hinge door;
a second illumination unit provided at the lower end portion of the first drawer;
a first opening and closing sensing unit including a reed switch provided at one of the lower end portion of the first hinge door and the upper end portion of the first drawer, and a magnet provided at the other one of the lower end portion of the first hinge door and the upper end portion of the first drawer;
a second opening and closing sensing unit including a reed switch provided at one of the lower end portion of the second hinge door and the upper end portion of the first drawer, and a magnet provided at the other one of the lower end portion of the second hinge door and the upper end portion of the first drawer; and
a third opening and closing sensing unit including a reed switch provided at one of the lower end portion of the first drawer and the upper end portion of the second drawer, and a magnet provided at the other one of the lower end portion of the first drawer and the upper end portion of the second drawer,
wherein the first illumination units and the second illumination unit are interlocked with the first opening and closing sensing unit, the second opening and closing sensing unit, and the third opening and closing sensing unit.

14. The refrigerator according to claim 13, further including an input unit provided to input operation data of at least one of the first illumination units and the second illumination unit.

15. The refrigerator according to claim 14, wherein a user inputs the operation data of the first illumination units and the second illumination unit through the input unit, and the first illumination units and the second illumination unit are operated according to the operation data input by the user.

16. A refrigerator comprising:
a main body provided with a first storage compartment and a second storage compartment, vertically divided from each other;
a first storage compartment door and a second storage compartment door vertically disposed so as to open and close the first storage compartment and the second storage compartment of the main body;
an illumination unit provided at least one of the lower end portion of the first storage compartment door and the upper portion of the second storage compartment; and
an opening and closing sensing unit to sense the opening and closing state of at least one of the first storage compartment door and the second storage compartment door and interlocking the illumination unit,
wherein the illumination unit is operated when the second storage compartment door is opened and closed.

17. A refrigerator comprising:
a main body in which a first storage compartment and a second storage compartment are defined;
a partition provided between the first storage compartment and the second storage compartment, to separate the first storage compartment and the second storage compartment from each other;
a first storage compartment door to open or close the first storage compartment;
a second storage compartment door to open or close the second storage compartment;
a illumination unit provided on at least one of a lower end of the first storage compartment door and a lower end of the partition; and
an input device using which a user inputs an operational mode of the illumination unit.

18. The refrigerator according to claim 17, further comprising an opening and closing sensing unit to sense the opening and closing state of at least one of the first storage compartment door and the second storage compartment door and interlocking the illumination unit.

19. The refrigerator according to claim 18, wherein the opening and closing sensing unit includes a reed switch provided at least one of the lower end portion of the first storage compartment door and the upper end portion of the second storage compartment door, and a magnet provided at the other one of the lower end portion of the first storage compartment door and the upper end portion of the second storage compartment door and interacting with the reed switch.

20. The refrigerator according to claim 19, wherein the opening and closing states of the first storage compartment door and the second storage compartment door are simultaneously sensed by the interaction between the reed switch and the magnet.
